(19) United States
(12) Patent Application Publication
(10) Pub. No.: US 2022/0229942 A1
(43) Pub. Date: Jul. 21, 2022

(54) HYBRID COLLAPASE STRENGTH FOR BOREHOLE TUBULAR DESIGN

(71) Applicant: Landmark Graphics Corporation, Houston, TX (US)

(72) Inventors: Zhengchun Liu, Sugar Land, TX (US); Robello Samuel, Cypress, TX (US); Adolfo Gonzales, Houston, TX (US); Yongfeng Kang, Katy, TX (US); Jenny Z. Xie, Sugar Land, TX (US)

(21) Appl. No.: 17/152,300

(22) Filed: Jan. 19, 2021

(51) Int. Cl. G06F 30/10; E21B 47/007; E21B 47/08

(52) U.S. Cl. CPC G06F 30/10; E21B 47/007; G06F 2113/14; E21B 2200/20; E21B 47/08

(57) ABSTRACT

The disclosure presents processes for improving the design phase of tubular structures to be used downhole in a borehole. A hybrid collapse strength model can be utilized that uses a linear collapse strength model for an initial percentage range based on the initial wall thickness of the tubular structure. A standards collapse strength model can be used once a wall thickness threshold is not satisfied. In some aspects, a transition collapse strength model can be used prior to the standards collapse strength model to avoid discontinuities in the analysis. The hybrid collapse strength model can enable more efficient use of tubular structures, designing a longer operational lifetime, or the use of thinner structures while maintaining a satisfactory operational lifetime. Lower operational costs of the borehole can be achieved through using less expensive tubular structures and through a reduction of costs associated with replacing a section of casing within the borehole.

### TECHNICAL FIELD

This application is directed, in general, to tubular structure design for boreholes and, more specifically, to using a collapse strength for tubular structure designs.

### BACKGROUND

When developing and drilling boreholes, it is important to be able to support the borehole against collapse, ensure borehole integrity, and protect equipment that is lowered into the borehole. In addition, the borehole may be exposed to varying temperatures, formation fluids, electromagnetic radiation, and varying types of minerology. These factors can adversely affect the equipment lowered into the borehole. Tubular structures, for example, casing or pipe, can assist in protecting the equipment, as well as in some aspects of supporting the borehole against formation leakage and collapse. It would be beneficial to improve the efficiency of the borehole design, by more accurately predicting the operational wear on the tubular structures used within the borehole.

### SUMMARY

In one aspect a method is disclosed. In one embodiment, the method includes (1) receiving input parameters for a tubular structure design of a tubular structure of a borehole, wherein the tubular structure design utilizes a hybrid collapse strength model, (2) updating a wear allowance of the tubular structure, wherein an initial wall thickness of the tubular structure is updated to an adjusted wall thickness using the input parameters, (3) calculating a collapse rating utilizing the hybrid collapse strength model, the input parameters, and the wear allowance, wherein the hybrid collapse strength model includes a designated collapse strength model, and (4) computing a collapse safety factor utilizing the collapse rating.

In a second aspect a hybrid collapse strength modeler system is disclosed. In one embodiment, the hybrid collapse strength modeler system includes (1) a parameter receiver, capable to receive input parameters, (2) a result transceiver, capable of communicating result parameters, and (3) a wear allowance modeler, capable of utilizing the input parameters to determine one or more designated collapse strength models to apply to a tubular structure for a tubular structure design for a borehole, and to generate the result parameters.

In a third aspect a computer program product having a series of operating instructions stored on a non-transitory computer-readable medium that directs a data processing apparatus when executed thereby to perform operations is disclosed. In one embodiment, the operations include (1) receiving input parameters for a tubular structure design of a tubular structure of a borehole, wherein the tubular structure design utilizes a hybrid collapse strength model, (2) updating a wear allowance of the tubular structure, wherein an initial wall thickness of the tubular structure is updated to an adjusted wall thickness using the input parameters, (3) calculating a collapse rating utilizing the hybrid collapse strength model, the input parameters, and the wear allowance, wherein the hybrid collapse strength model includes a designated collapse strength model, and (4) computing a collapse safety factor utilizing the collapse rating.

### BRIEF DESCRIPTION

Reference is now made to the following descriptions taken in conjunction with the accompanying drawings, in which:

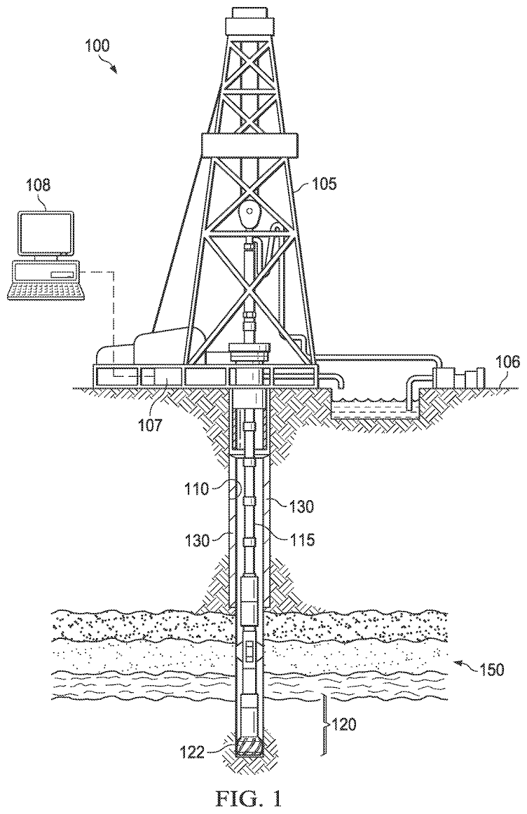

FIG. 1 is an illustration of a diagram of an example drilling system;

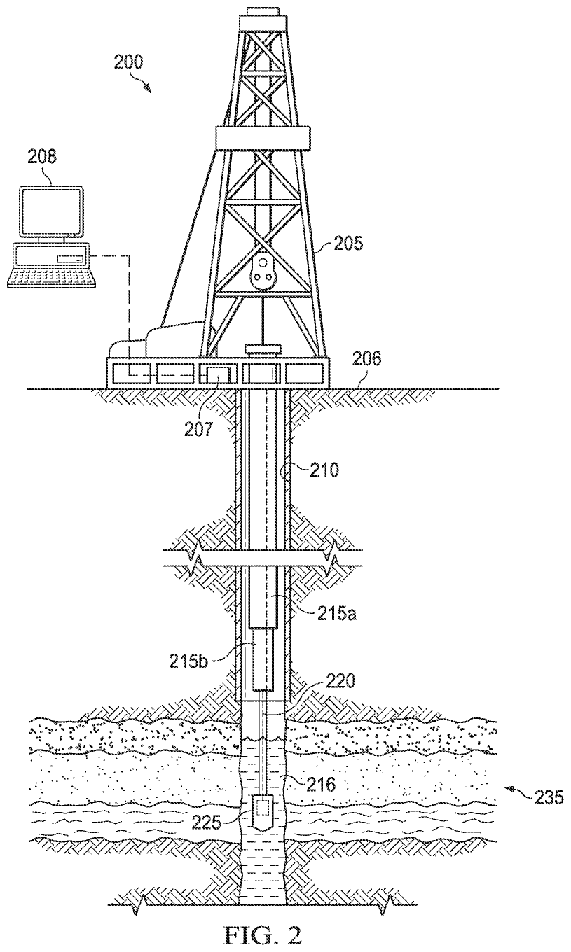

FIG. 2 is an illustration of a diagram of an example wireline system;

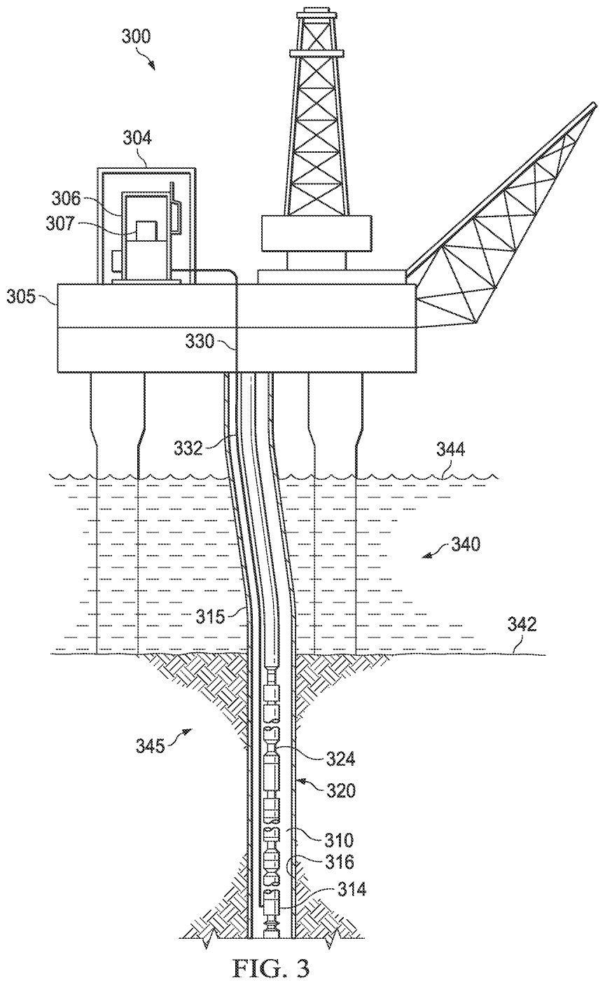

FIG. 3 is an illustration of a diagram of an example offshore system;

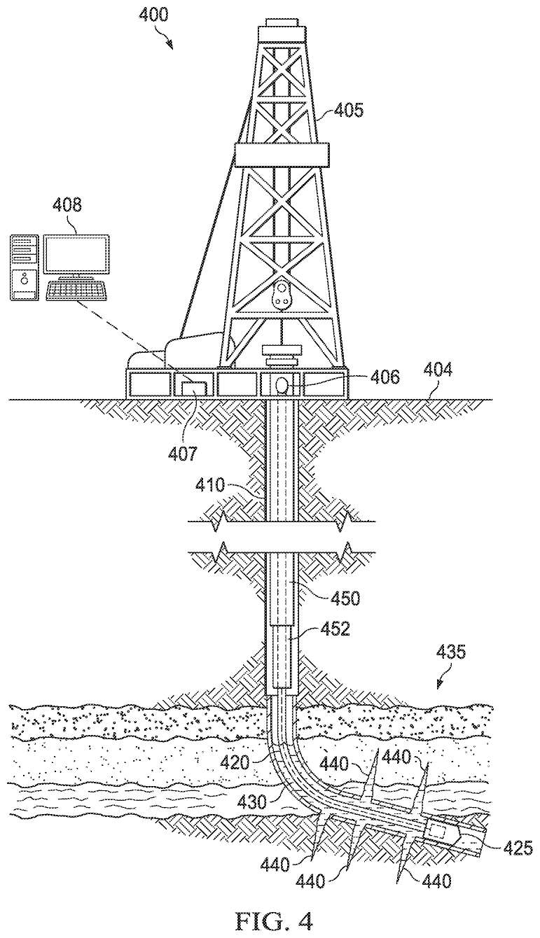

FIG. 4 is an illustration of a diagram of an example hydraulic fracturing system;

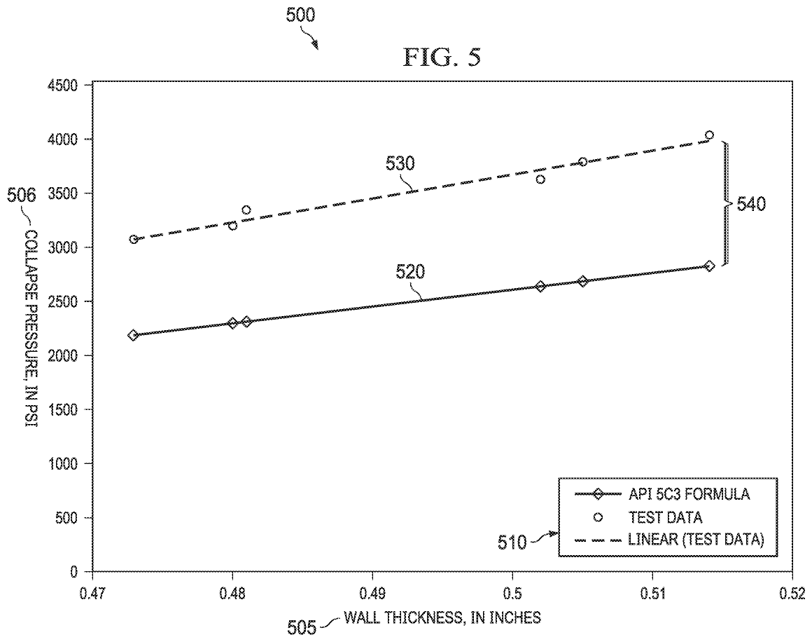

FIG. 5 is an illustration of a diagram of an example graph showing a gap between the API 5C3 collapse strength model and a controlled test;

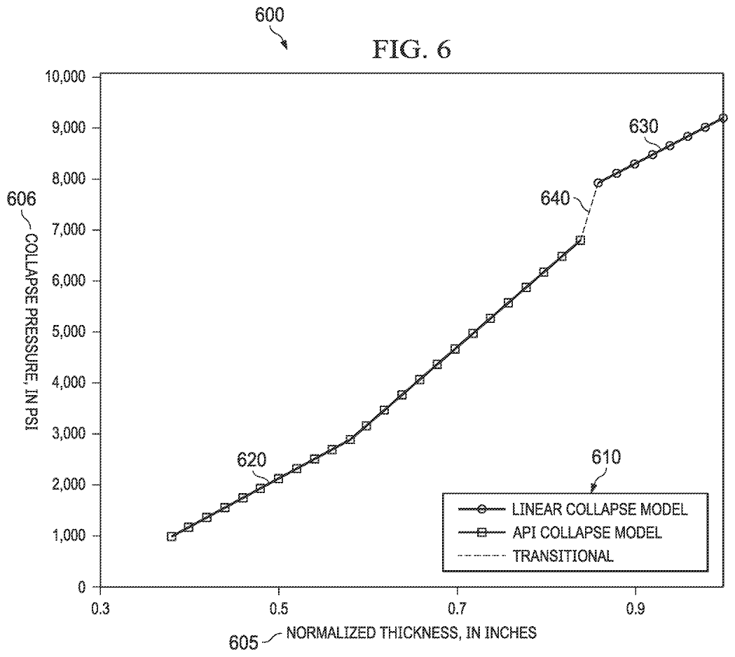

FIG. 6 is an illustration of a diagram of an example graph showing a hybrid collapse strength model;

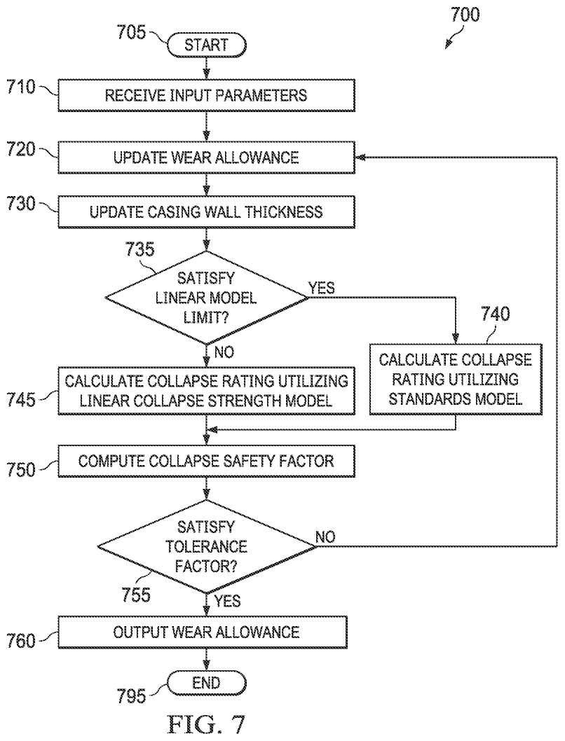

FIG. 7 is an illustration of a flow diagram of an example method using a hybrid collapse strength model;

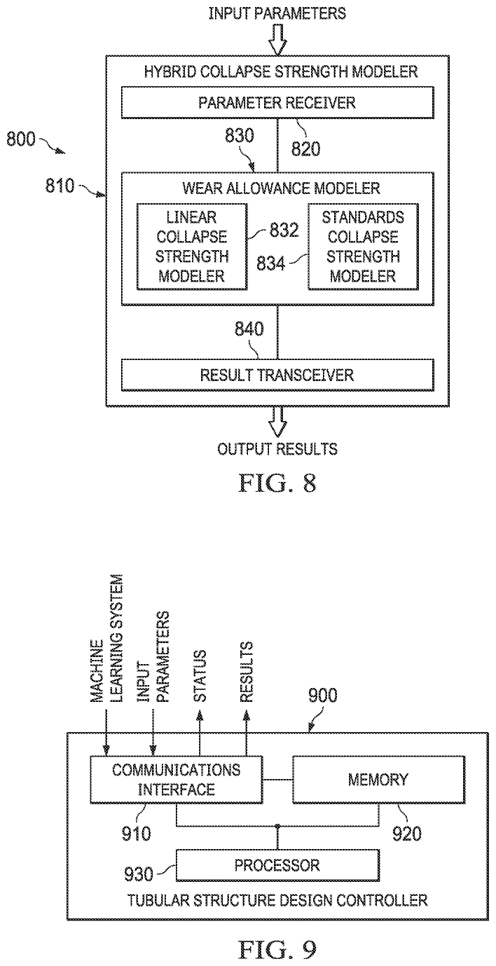

FIG. 8 is an illustration of a block diagram of an example hybrid collapse strength modeler system; and

FIG. 9 is an illustration of a block diagram of an example of a tubular structure design controller according to the principles of the disclosure.

### DETAILED DESCRIPTION

When designing borehole systems, one factor to be considered is the type of tubular structures to be used in the borehole. During the operational lifetime of a borehole, tubular structures can be subject to combined damage caused by corrosion and mechanical wear. It is beneficial to conduct detailed stress analyses including the damage factors at the stage of tubular structure design. To ensure the tubular structure meets the operational goal, such as satisfying the operational lifetime of the borehole or another specified time interval, the estimated total amount of material loss or corrosion, e.g., metal loss or other material loss, can be compared against the determined maximum allowable wear, or a maximum allowable material loss, for a safety check of the design.

Tubular structures can vary as to the material used and the thickness of the wall of the tubular structure. The type of tubular structure used at a particular depth can be different than the tubular structure used in another portion of the borehole. During the design phase, it is beneficial to select a tubular structure that can maximize the efficiency of the borehole operations at a particular location within the borehole.

Additional cost can be incurred in replacing a section of the tubular structure if a portion or section of the tubular structure wears out sooner than planned. Wear on the tubular structure can occur due to various factors, for example, physical or mechanical wearing due to trip in or trip out of tools such as a wireline tool or a drill string, physical or mechanical wearing due to rotation of a drill string, corrosion factors, pressure factors, temperature factors, minerology factors, and other factors.

Typically, users design the tubular structures against various loads such as axial, burst, and collapse. Collapse design involves modeling and simulation of tubular structure collapse strength and tubular structure collapse loads. Conventionally, tubular structure collapse strength can be calculated using the American Petroleum Institute (API) bulletin 5C3 collapse strength model or another industry standards collapse strength model. In some aspects, the API 5C3 model may underestimate the collapse resistance of special-type high-collapse tubular structures. As a result, the tubular structure could be over-designed in terms of collapse, which is not cost effective for the borehole system. Tubular structures can be casing, tubing, drill strings, downhole tools, and other types of tubular structures.

The API 5C3 model is used in the descriptions, examples, demonstrations, and figures throughout the disclosure for illustrative purposes. In other aspects, various standards collapse strength models now known or later developed can be used in place of the API 5C3 model. The casing type of tubular structure is used in the descriptions, examples, demonstrations, and figures throughout the disclosure for illustrative purposes. In other aspects, various types of tubular structures now know or later developed can be used in place of the casing type of tubular structure.

This disclosure presents process and methods to improve the accuracy of calculations for collapse strength of high-collapse tubular structures, thereby reducing costs on tubular structure sections while continuing to meet or exceed borehole safety and integrity goals. Based on observations of tubular structure collapse strength versus tubular structure wall thickness, a determined percentage range can be utilized with a linear collapse strength model for a portion of the collapse strength calculation. Tubular structure collapse strength can be linearly related to the wall thickness of the tubular structure when the wall thickness is at or above a linear model limit, for example, 90.0%, 85.0%, 83.0%, or other values, of the initial wall thickness. Below the linear model limit, the standards collapse strength model can be used.

In some aspects, the disclosed processes and methods can utilize a hybrid approach to tubular structure design, in which the linear collapse strength model can be combined with the standards collapse strength model to produce a hybrid collapse strength model. In some aspects, a transition model can be utilized to bridge the linear collapse strength model and the standards collapse strength model to avoid a discontinuity of the hybrid collapse strength model at the point where the linear and standards models are proximate. The gap covered by the transition model can be various values, such as 0.1%, 0.5%, 2.0%, or other values. In some aspects, the hybrid collapse strength model can be applied to the calculation of a tubular structure wear allowance, such as for a casing section or a drill pipe.

Using the specified linear model limit, the collapse rating can be calculated using Equation 1.

Equation 1: Example Collapse Rating Calculation Using a Linear Model Limit Parameter

$$P c = \frac{t}{t 0} * Pc 0 , \\ where \frac{L L}{100} * t 0 \leq t \leq t 0$$

where Pc is the calculated collapse rating,

Pc0 is the collapse rating of the initial wall thickness of the tubular structure,

t0 is the initial wall thickness of the tubular structure,

t is the adjusted wall thickness of the tubular structure as wear and corrosion occur, and

LL is the linear model limit parameter in the range of 0.0 to 100.0, typically can be in the range of 70.0 and 99.0. The LL can be converted to a percentage in the calculations and applied to the initial wall thickness.

In some aspects, the tubular structure can exhibit characteristics where the collapse rating is not proportional to, while continuing to be linearly related to, the tubular structure wall thickness. In these aspects, Equation 2 can be utilized to calculate a new collapse rating, where the range covered by the linear collapse strength model utilizes a different collapse rating than the standards portion.

Equation 2: Example Non-Proportional Collapse Rating

$$P c = P c 0 - ( P c 0 - P c 1 ) \frac{( 1 - \frac{t}{t 0} )}{( 1 - \frac{L L}{100} )} , \\ where \frac{L L}{100} * t 0 \leq t \leq t 0$$

where Pc1 is the linear model limit collapse rating.

In some aspects, a discontinuity can occur when combining the linear collapse strength model and the standards collapse strength model when generating the hybrid collapse strength model. To compensate for the discontinuity, a transition range can be included as part of the hybrid collapse strength model (see, for example, FIG. 6, transition line 640). The transition range can cover a range from the linear collapse strength model to the standards collapse strength model. The transition range can be specified parameter. For example, the hybrid collapse strength model can utilize a linear model limit of 90.0 and a transition range of 3.0, which means that the collapse rating would be calculated using the linear collapse strength model for a tubular structure wall thickness from the initial thickness to 90.0% of the initial wall thickness. The transition collapse strength model would be used for the wall thicknesses less than 90.0% to 87.0% of the initial wall thickness. The standards collapse strength model would be used for the wall thickness less than 87.0% of the initial wall thickness. Equation 3 is an example of calculating the transition collapse rating.

Equation 3: Example Transition Collapse Rating

$$Transitional Pc = Pc 1 - ( \frac{L L}{100} - \frac{t}{t 0} ) * \frac{( P c 1 - P {c}_{api} )}{transitionRange}$$

where Pcₐₚᵢ is the standards collapse rating at the linear model limit, and

transitionRange is the decimal value of the range used for the transition collapse strength model.

Turning now to the figures, FIG. 1 is an illustration of a diagram of an example drilling system 100, for example, a logging while drilling (LWD) system, a measuring while drilling (MWD) system, a seismic while drilling (SWD) system, a telemetry while drilling (TWD) system, injection well system, extraction well system, and other borehole systems. Drilling system 100 includes a derrick 105, a well site controller 107, and a computing system 108. Well site controller 107 includes a processor and a memory and is configured to direct operation of drilling system 100. Derrick 105 is located at a surface 106.

Extending below derrick 105 is a borehole 110 with downhole tools 120 at the end of a drill string 115. Downhole tools 120 can include various downhole tools, such as a formation tester or a bottom hole assembly (BHA). At the bottom of downhole tools 120 is a drilling bit 122. Other components of downhole tools 120 can be present, such as a local power supply (e.g., generators, batteries, or capacitors), telemetry systems, sensors, transceivers, and control systems. Borehole 110 is surrounded by subterranean formation 150.

Well site controller 107 or computing system 108 which can be communicatively coupled to well site controller 107, can be utilized to communicate with downhole tools 120, such as sending and receiving telemetry, data, instructions, subterranean formation measurements, and other information. Computing system 108 can be proximate well site controller 107 or be a distance away, such as in a cloud environment, a data center, a lab, or a corporate office. Computing system 108 can be a laptop, smartphone, PDA, server, desktop computer, cloud computing system, other computing systems, or a combination thereof, that are operable to perform the processes described herein. Well site operators, engineers, and other personnel can send and receive data, instructions, measurements, and other information by various conventional means, now known or later developed, with computing system 108 or well site controller 107. Well site controller 107 or computing system 108 can communicate with downhole tools 120 using conventional means, now known or later developed, to direct operations of downhole tools 120.

Casing 130 can act as barrier between subterranean formation 150 and the fluids and material internal to borehole 110, as well as drill string 115. As drill string 115 rotates within borehole 110 or during trip in or trip out operations, there can be wear of casing 130. Casing 130 should be designed to account for this wear for the operational lifetime of borehole 110. Replacing casing sections of casing 130 can be scheduled though it can be more cost effective to design casing 130 prior to placement to avoid replacement during the operational lifetime of borehole 110.

FIG. 2 is an illustration of a diagram of an example wireline system 200. Wireline system 200 depicts a wireline well system and includes a derrick 205, a well site controller 207, and a computing system 208. Well site controller 207 includes a processor and a memory and is operable to direct operation of wireline system 200. Derrick 205 is located at a surface 206. Computing system 208 can be proximate well site controller 207 or be a distance away, such as in a cloud environment, a data center, a lab, or a corporate office. Computing system 208 can be a laptop, smartphone, PDA, server, desktop computer, cloud computing system, and other computing systems.

Extending below derrick 205 is a borehole 210, with a cased section 215a, a cased section 215b, and one uncased section 216. Wireline 220 is inserted in borehole 210 to hold a downhole tool 225. Borehole 210 is surrounded by a subterranean formation 235 which includes a hydrocarbon reservoir. Cased section 215a and cased section 215b can be designed to withstand subterranean formation 235 as well as the operations of downhole tool 225. The design parameters of cased section 215a can vary from the design parameters of cased section 215b. It is beneficial for cased section 215a and cased section 215b to be designed for the operational lifetime of borehole 210 to minimize the cost of replacing a section of casing.

FIG. 3 is an illustration of a diagram of an example offshore system 300 with an electric submersible pump (ESP) assembly 320. ESP assembly 320 is placed downhole in a borehole 310 below a body of water 340, such as an ocean or sea. Borehole 310, protected by casing, screens, or other structures, is surrounded by subterranean formation 345. ESP assembly 320 can be used for onshore operations. ESP assembly 320 includes a well controller 307 (for example, to act as a speed and communications controller of ESP assembly 320), an ESP motor 314, and an ESP pump 324.

Well controller 307 is placed in a cabinet 306 inside a control room 304 on an offshore platform 305, such as an oil rig, above water surface 344. Well controller 307 is configured to adjust the operations of ESP motor 314 to improve well productivity. In the illustrated aspect, ESP motor 314 is a two-pole, three-phase squirrel cage induction motor that operates to turn ESP pump 324. ESP motor 314 is located near the bottom of ESP assembly 320, just above downhole sensors within borehole 310. A power/communication cable 330 extends from well controller 307 to ESP motor 314. A fluid pipe 332 fluidly couples equipment located on offshore platform 305 and ESP pump 324.

In some aspects, ESP pump 324 can be a horizontal surface pump, a progressive cavity pump, a subsurface compressor system, or an electric submersible progressive cavity pump. A motor seal section and intake section may extend between ESP motor 314 and ESP pump 324. A riser 315 separates ESP assembly 320 from water 340 until sub-surface 342 is encountered, and a casing 316 can separate borehole 310 from subterranean formation 345 at and below sub-surface 342. Perforations in casing 316 can allow the fluid of interest from subterranean formation 345 to enter borehole 310. The design of casing 316 should be sufficient to prevent borehole 310 from collapsing for the lifetime of operations of borehole 310.

FIG. 4 is an illustration of a diagram of an example hydraulic fracturing (HF) well system 400, which can be a well site where HF operations are occurring through the implementation of a HF treatment stage plan. HF well system 400 demonstrates a nearly horizontal wellbore undergoing a fracturing operation.

HF well system 400 includes surface well equipment 405 located at a surface 404, a well site controller 407, a surface HF pump system 406, and a computing system 408. In some aspects, well site controller 407 is communicatively connected to separate computing system 408, for example, a separate server, data center, cloud service, tablet, laptop, smartphone, or other types of computing systems capable of executing the processes and methods described herein. Computing system 408 can be located proximate to well site controller 407 or located a distance from well site controller 407.

Extending below surface 404 from surface well equipment 405 is a borehole 410. Borehole 410 can have zero or more cased sections, such as cased section 450 and cased section 452, and a bottom section that is uncased. Inserted into borehole 410 is a fluid pipe 420. The bottom portion of fluid pipe 420 has the capability of releasing downhole material 430, such as carrier fluid with diverter material, from fluid pipe 420 to subterranean formations 435 containing fractures 440. The release of downhole material 430 can be by perforations in the casing, by valves placed along fluid pipe 420, or by other release means. At the end of fluid pipe 420 is an end of pipe assembly 425, which can be one or more downhole tools or an end cap assembly.

As described in FIGS. 1-3, cased section 450 and cased section 452 can be designed to withstand subterranean formation 435 and operations internal of borehole 410 so as to reduce the chance that the respective cased sections would need to be replaced during the operational lifetime of borehole 410. The design of cased section 450 and cased section 452 can be optimized to minimize cost while satisfying the operational goal.

FIGS. 1, 2, and 4 depict onshore operations. Those skilled in the art will understand that the disclosure is equally well suited for use in offshore operations, such as shown in FIG. 3. FIGS. 1-4 depict specific borehole configurations, those skilled in the art will understand that the disclosure is equally well suited for use in boreholes having other orientations including vertical boreholes, horizontal boreholes, slanted boreholes, multilateral boreholes, and other borehole types.

FIG. 5 is an illustration of a diagram of an example graph 500 showing a gap between the API 5C3 collapse strength model and a controlled test. Graph 500 utilizes test data run through the API 5C3 collapse strength model and the same test data run through a controlled test. Graph 500 includes an x-axis 505 indicating the wall thickness of a selected tubular structure, in inches. A y-axis 506 indicates the collapse pressure in psi, e.g., the collapse rating. A key table 510 is shown indicating the data points collected using the API 5C3 collapse strength model as diamonds with a linear fit line that is a dashed line. The controlled test data is shown as circles with its linear fit line shown as a dotted line.

In plot area of graph 500, the API 5C3 collapse strength model data points and linear fit line are plotted as API line 520. The controlled test data points and linear fit line are plotted as test line 530. Test line 530 demonstrates that the measured collapse strength can be linearly related to the tubular structure wall thickness. Therefore, a linear collapse strength model for a specified range of percentages of initial wall thicknesses can be a satisfactory estimate for tubular structure wear allowance.

The distance between API line 520 and test line 530 varies over the various wall thicknesses and is represented by gap 540. Gap 540 represents the opportunity improvement of this disclosure, whereby a thinner wall thickness for tubular structures can be utilized to achieve the same or similar collapse pressure, e.g., collapse rating, as the API 5C3 collapse strength model. Thinner casing can be less expensive and use less space within the borehole, thereby increasing overall efficiency of the borehole operations.

FIG. 6 is an illustration of a diagram of an example graph 600 showing a hybrid collapse strength model. Graph 600 utilizes sample data run through a hybrid collapse strength model that includes the API 5C3 collapse strength model, as linear collapse strength model, and a transition collapse strength model. Graph 600 includes an x-axis 605 indicating the normalized wall thickness, in inches, of the tubular structure utilized. A y-axis 606 indicates the collapse pressure in psi, e.g., the collapse rating. A key table 610 is shown indicating the data points collected using the API 5C3 collapse strength model as squares with a linear fit line. The linear collapse strength model are shown as circles with a linear fit line. A transition collapse strength model is shown as a solid line.

In plot area of graph 600, the API 5C3 collapse strength model data points and linear fit line are plotted as API line 620. The linear collapse strength model data points and linear fit line are plotted as linear line 630. The transition collapse strength model connecting API line 620 and linear line 630 is transition line 640. Transition line 640 can be of a determined, default, or specified length, for example, 0.1%, 1.0%, 3.0%, or other values of the normalized wall thickness. In this example, transition line 640 is shown as being between approximately, 85.0% and 87.0% of the normalized wall thickness. The linear collapse strength model can be used for tubular structures at 100% of the normalized wall thickness down to the beginning of transition line 640, such as 87.0%. Transition line 640 can extend to 85.0% of the initial wall thickness at which point the API 5C3 collapse strength model calculations are utilized to calculate the remaining wall thickness over the remaining life of the operations of the borehole. The handling of the transition points between the various collapse strength models is arbitrary and can utilize various combinations of greater than, less than, or equal to comparisons to define each transition point.

FIG. 7 is an illustration of a flow diagram of example method 700 using a hybrid collapse strength model. Method 700 can be performed on a computing system, such as a well site controller, a server, a laptop, a mobile device, a cloud computing system, or other computing system capable of receiving the input parameters and outputting result parameters. Other computing systems can be a smartphone, a mobile phone, a PDA, a laptop computer, a desktop computer, a server, a data center, a cloud environment, or other computing system. The computing system can be located proximate a borehole or can be located in a data center, a cloud environment, a lab, a corporate office, or other distance locations. Method 700 can be encapsulated in software code or in hardware, for example, an application, a code library, a dynamic link library, a module, a function, a RAM, a ROM, and other software and hardware implementations. The software can be stored in a file, database, or other computing system storage mechanism. Method 700 can be partially implemented in software and partially in hardware.

Method 700 starts at a step 705 and proceeds to a step 710 where input parameters are received. The input parameters can include, but is not limited to, the wall thickness of the selected tubular structure, the anticipated downhole conditions, for example, minerology factors, temperature factors, pressure factors, measured depth, true vertical depth, fluid exposure factors, electromagnetic exposure factors, and other downhole conditions, a selected tolerance factor, a designated standards collapse strength model to utilize, a linear model limit, and a transition range. In some aspects, default parameters can be utilized in place of receiving one or more of the input parameters, for example, the linear model limit can be defaulted to 90.0% or the transition range can be defaulted to 2.0%. In some aspects, a machine learning algorithm can be used in place of some of the input parameters, for example, the linear model limit and the transition range can be determined using an output from the machine learning algorithm to improve the efficiency of the method results.

Proceeding to a step 720, a wear allowance parameter is updated utilizing the input parameters. The wear allowance parameter indicates the amount of wear allowable on the tubular structure before needing to be replaced. In a step 730, the tubular structure wall thickness is updated using the output from step 720 and the input parameters. The process used in step 720 and step 730 can utilize conventional processes.

In a decision step 735, the linear model limit can be compared to the updated tubular structure wall thickness as output by step 730. The linear model limit can be various values, for example, 90.0% of the initial wall thickness, 80.0% of the initial wall thickness, or other values within the inclusive range of 0.0% and 100.0%. 0.0% would indicate that the linear collapse strength model is used for the calculations. 100.0% would indicate that the standards collapse strength model is used for the calculations. Typical values can be 60.0% to 95.0%, or other ranges. If the linear model limit is satisfied, e.g., that the wall thickness has been calculated to be reduced to the limit value, the ‘Yes’ option is selected. If the linear model limit is not satisfied, then the ‘No’ option is selected.

Proceeding from the ‘Yes’ option in decision step 735, method 700 proceeds to step 740. In step 740, a designated collapse strength model, such as a standards collapse strength model, for example, the API 5C3 collapse strength model, is utilized to calculate the collapse rating for the given set of input parameters. In some aspects, a transition collapse strength model can be applied, e.g., be the designated collapse strength model, over a specified transition range prior to utilizing the standards collapse strength model.

Proceeding from the ‘No’ option in decision step 735, method 700 proceeds to step 745. In step 745, the linear collapse strength model is utilized as the designated collapse strength model to calculate the collapse rating for the given set of input parameters.

From step 740 or step 745, method 700 proceeds to a step 750 where the collapse safety factor is computed utilizing the respective output from step 740 or step 745. In a decision step 755 the tolerance factor can be evaluated to determine if it is satisfied. For example, the difference between the collapse safety factor and a design safety factor can be compared to the tolerance factor, such as shown in Equation 4. If the tolerance factor is satisfied, the ‘Yes’ option is selected. If the tolerance factor is not satisfied, e.g., an unsatisfactory comparison, the ‘No’ option is selected.

Equation 4: Example Comparison of the Collapse Safety Factor and the Design Safety Factor

|SF−DF|<tolerance factor

where SF is the collapse safety factor,

DF is the design safety factor, and

Tolerance factor is the tolerance factor received in the input parameters or from a default parameter.

From the ‘No’ option of decision step 755, method 700 proceeds to step 720 to enable further refinements of the wear allowance. From the ‘Yes’ option of decision step 755, method 700 proceeds to step 760. In step 760, the wear allowance and other computed parameters can be output to one or more systems. Method 700 ends at a step 795.

FIG. 8 is an illustration of a block diagram of an example hybrid collapse strength modeler system 800, which can be implemented using one or more computing systems, for example, a well site controller, a reservoir controller, a data center, a cloud environment, a server, a laptop, a smartphone, a mobile phone, a tablet, and other computing systems. The computing system can be located proximate the well site, or a distance from the well site, such as in a data center, cloud environment, corporate location, a lab environment, or another location. The computing system can be a distributed system having a portion located proximate the borehole and a portion located remotely from the well site. In some aspects, hybrid collapse strength modeler system 800 can be implemented using tubular structure design controller 900 of FIG. 9.

Hybrid collapse strength modeler system 800, or a portion thereof, can be implemented as an application, a code library, a dynamic link library, a function, a module, other software implementation, or combinations thereof. In some aspects, hybrid collapse strength modeler system 800 can be implemented in hardware, such as a ROM, a graphics processing unit, or other hardware implementation. In some aspects, hybrid collapse strength modeler system 800 can be implemented partially as a software application and partially as a hardware implementation.

Hybrid collapse strength modeler system 800 has a hybrid collapse strength modeler 810 that includes a parameter receiver 820, a wear allowance modeler 830, a linear collapse strength modeler 832, a standards collapse strength modeler 834, and a result transceiver 840. The result parameters and outputs from hybrid collapse strength modeler 810 can be communicated to another system, such as one or more of a well site controller, a computing system, or a user. In some aspects, the communicated result parameters can be used as inputs to a design operation for the borehole to identify appropriate casing to be utilized. A memory or data storage of hybrid collapse strength modeler 810 can be configured to store the processes and algorithms for directing the operations thereof.

Parameter receiver 820 can receive input parameters to direct further operations. The input parameters can be parameters, instructions, directions, data, and other information to enable or direct the remaining processing of hybrid collapse strength modeler system 800. For example, the input parameters can include the wall thickness of the selected tubular structure, the anticipated downhole conditions, for example, minerology factors, temperature factors, pressure factors, measured depth, true vertical depth, fluid exposure factors, electromagnetic exposure factors, and other downhole conditions, a selected tolerance factor, a designated standards collapse strength model to utilize, a linear model limit, and a transition range.

Wear allowance modeler 830 can implement the processes and methods as described herein utilizing the input parameters. Wear allowance modeler 830 can use one or more algorithms, such as machine learning, decision tree, random forest, logistic regression, linear, and other algorithms to determine the wear allowance parameter. Wear allowance modeler 830 can direct operation of the linear collapse strength modeler 832 and the standards collapse strength modeler 834.

In some aspects, the transition collapse strength modeler can be implemented as a separate component or be combined in wear allowance modeler 830, linear collapse strength modeler 832, or standards collapse strength modeler 834. In some aspects, the linear collapse strength modeler 832 and the standards collapse strength modeler 834 can be implemented in the same modeler. Hybrid collapse strength modeler system 800 demonstrates a functional view of the disclosure, and the described functions can be implemented in one or more functional units.

Result transceiver 840 can communicate one or more generated outputs and result parameters, such as a wear allowance parameter, to one or more other systems, such as a well site controller, a computing system, a user, or other borehole related systems. Parameter receiver 820 and result transceiver 840 can be, or can include, conventional interfaces configured for transmitting and receiving data.

FIG. 9 is an illustration of a block diagram of an example of a tubular structure design controller 900 according to the principles of the disclosure. Tubular structure design controller 900 can be stored on a single computer or on multiple computers. The various components of tubular structure design controller 900 can communicate via wireless or wired conventional connections. A portion of tubular structure design controller 900 can be located downhole at one or more locations and other portions of tubular structure design controller 900 can be located on a computing device or devices located at the surface or a distant location. In some aspects, tubular design controller 900 can be wholly located at a surface or distant location. In some aspects, tubular structure design controller 900 is part of a borehole planner system or a wellsite job planner system, and can be integrated in a single device.

Tubular structure design controller 900 can be configured to perform the various functions disclosed herein including receiving input parameters and generating result parameters from an execution of a stress analysis using a hybrid modeler, such as a thermal modeler and a strength modeler. Tubular structure design controller 900 includes a communications interface 910, a memory 920, and a processor 930.

Communications interface 910 is configured to transmit and receive data. For example, communications interface 910 can receive input parameters regarding the tubular structure and the anticipated conditions that will be experienced downhole a borehole. Communications interface 910 can transmit the result parameters and other generated parameters, such as calculated safety factors over time at various borehole depths. In some aspects, communications interface 910 can transmit a status, such as a success or failure indicator of tubular structure design controller 900 regarding receiving the input parameters, transmitting the result parameters, or generating the result parameters. In some aspects, communications interface 910 can receive input parameters from a machine learning system, such as borehole conditions that could be experienced downhole during the time interval of the analysis. Communications interface 910 can communicate via communication systems used in the industry. For example, wireless or wired protocols can be used. Communication interface 910 is capable of performing the operations as described for parameter receiver 820 and result transceiver 840.

Memory 920 can be configured to store a series of operating instructions that direct the operation of processor 930 when initiated, including the code representing the algorithms for determining the safety factors for a hybrid collapse strength model. Memory 920 is a non-transitory computer readable medium. Multiple types of memory can be used for data storage and memory 920 can be distributed.

Processor 930 can be configured to determine result parameters and statuses utilizing the received input parameters, and, if provided, the machine learning system inputs. For example, the processor 930 can perform a collapse rating analysis using a hybrid collapse strength model on the tubular structure by applying the anticipated downhole conditions. Processor 930 can be configured to direct the operation of the tubular structure design controller 900. Processor 930 includes the logic to communicate with communications interface 910 and memory 920, and perform the functions described herein to determine the result parameters and statuses. Processor 930 is capable of performing or directing the operations as described by wear allowance modeler 830, linear collapse strength modeler 832, and standards collapse strength modeler 834.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, because the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
receiving input parameters for a tubular structure design of a tubular structure of a borehole, wherein the tubular structure design utilizes a hybrid collapse strength model;
updating a wear allowance of the tubular structure, wherein an initial wall thickness of the tubular structure is updated to an adjusted wall thickness using the input parameters;
calculating a collapse rating utilizing the hybrid collapse strength model, the input parameters, and the wear allowance, wherein the hybrid collapse strength model includes a designated collapse strength model; and
computing a collapse safety factor utilizing the collapse rating.

2. The method as recited in claim 1, further comprising:
comparing the collapse safety factor to a design safety factor utilizing a tolerance factor, wherein an unsatisfactory comparison returns to the updating; and
communicating one or more of the collapse rating, the wear allowance, or the adjusted wall thickness to a second system to be used for the tubular structure design.

3. The method as recited in claim 1, wherein the calculating further comprises:
utilizing a linear model limit and the initial wall thickness to select the designated collapse strength model.

4. The method as recited in claim 3, wherein the designated collapse strength model is one of a linear collapse strength model, a transition collapse strength model, or a standards collapse strength model.

5. The method as recited in claim 4, wherein the utilizing further comprises:
first selecting the linear collapse strength model when the linear model limit is satisfied; and
second selecting the standards collapse strength model when the linear model limit is not satisfied.

6. The method as recited in claim 5, wherein the second selecting further comprises:
applying the transition collapse strength model for a transition range prior to using the standards collapse strength model.

7. The method as recited in claim 1, wherein the input parameters include at least one of the initial wall thickness, one or more downhole conditions, a measured depth, a true vertical depth, fluid exposure factors, electromagnetic exposure factors, a tolerance factor, a designated standards collapse strength model, a linear model limit, or a transition range.

8. The method as recited in claim 7, wherein the one or more downhole conditions is one or more of minerology factors, temperature factors, or pressure factors.

9. The method as recited in claim 1, wherein the designated collapse strength model is an API 5C3 collapse strength model.

10. A hybrid collapse strength modeler system, comprising:
a parameter receiver, capable to receive input parameters;
a result transceiver, capable of communicating result parameters; and
a wear allowance modeler, capable of utilizing the input parameters to determine one or more designated collapse strength models to apply to a tubular structure for a tubular structure design for a borehole, and to generate the result parameters.

11. The hybrid collapse strength modeler system as recited in claim 10, wherein the input parameters comprise one or more of an initial wall thickness of the tubular structure and a wear allowance of the tubular structure.

12. The hybrid collapse strength modeler system as recited in claim 11, wherein the wear allowance modeler further comprises:
a linear collapse strength modeler, capable of adjusting the initial wall thickness and the wear allowance using a linear collapse strength model while a linear model limit is satisfied.

13. The hybrid collapse strength modeler system as recited in claim 11, wherein the wear allowance modeler further comprises:
a standards collapse strength modeler, capable of adjusting the initial wall thickness and the wear allowance using a standards collapse strength model while a linear model is not satisfied.

14. The hybrid collapse strength modeler system as recited in claim 13, wherein the wear allowance modeler further comprises:
a transition collapse strength modeler, capable of adjusting the initial wall thickness and the wear allowance using a transition collapse strength model for a transition range while the linear model is not satisfied and used prior to the standards collapse strength model.

15. A computer program product having a series of operating instructions stored on a non-transitory computer-readable medium that directs a data processing apparatus when executed thereby to perform operations, the operations comprising:
receiving input parameters for a tubular structure design of a tubular structure of a borehole, wherein the tubular structure design utilizes a hybrid collapse strength model;
updating a wear allowance of the tubular structure, wherein an initial wall thickness of the tubular structure is updated to an adjusted wall thickness using the input parameters;
calculating a collapse rating utilizing the hybrid collapse strength model, the input parameters, and the wear allowance, wherein the hybrid collapse strength model includes a designated collapse strength model; and
computing a collapse safety factor utilizing the collapse rating.

16. The computer program product as recited in claim 15, further comprising:
comparing the collapse safety factor to a design safety factor utilizing a tolerance factor, wherein an unsatisfactory comparison returns to the updating; and
communicating one or more of the collapse rating, the wear allowance, or the adjusted wall thickness to a second system to be used for the tubular structure design.

17. The computer program product as recited in claim 15, wherein the calculating further comprises:
utilizing a linear model limit and the initial wall thickness to select the designated collapse strength model.

18. The computer program product as recited in claim 17, wherein the designated collapse strength model is one of a linear collapse strength model, a transition collapse strength model, or a standards collapse strength model.

19. The computer program product as recited in claim 18, wherein the utilizing further comprises:
first selecting the linear collapse strength model when the linear model limit is satisfied; and
second selecting the standards collapse strength model when the linear model limit is not satisfied.

20. The computer program product as recited in claim 19, wherein the second selecting further comprises:
applying the transition collapse strength model for a transition range prior to using the standards collapse strength model.
